(19) United States
(12) Patent Application Publication
(10) Pub. No.: US 2023/0104024 A1
(43) Pub. Date: Apr. 6, 2023

(54) APPLICATION MANAGEMENT PROGRAM, INFORMATION PROCESSING DEVICE, AND APPLICATION MANAGEMENT SYSTEM

(71) Applicant: Yappli Inc., Tokyo (JP)

(72) Inventor: Masashi SANO, Tokyo (JP)

(21) Appl. No.: 17/980,552

(22) Filed: Nov. 4, 2022

Related U.S. Application Data
(63) Continuation of application No. PCT/JP2021/015688, filed on Apr. 16, 2021.

(30) Foreign Application Priority Data
May 7, 2020 (JP) 2020-082059

(51) Int. Cl. G06F 9/54

(52) U.S. Cl. CPC G06F 9/542

(57) ABSTRACT

Provided are an application management program, an information processing device, and an application management system that make it possible to confirm a notification to an application and the content of the notification in advance on a specific terminal and make it possible to confirm the notification in advance even when a change is made to the application. An application management server includes: an application editing means that edits test application information; information distribution means that distributes test application information 113ti to a test terminal and distributes actual application information to terminals a, b, c, . . . ; and a notification means that carries out notification processing of notification content information 112a to the test terminal in response to reception of a test notification request together with the notification content information from the outside.

### CROSS-REFERENCE TO RELATED APPLICATIONS

The present application is a bypass continuation application based on and claims the benefit of priority from the prior Japanese patent application 2020-082059 filed on May 7, 2020, and PCT Application No. PCT/JP2021/015688 filed Apr. 16, 2021, the entire contents of which are incorporated herein by reference.

### TECHNICAL FIELD

The embodiments relate to an application management program, an information processing device, and an application management system.

### BACKGROUND ART

As a conventional technique, there has been proposed an information processing device that commonly provides a push notification mechanism to a plurality of applications and narrows down users to be push notification targets according to a dynamically changing user state (see, for example, Patent Literature 1).

The information processing device disclosed in Patent Literature 1 acquires an attribute value of a user regarding a plurality of attributes defined by a provider of an application in association with the application and the user, holds the attribute value as user information, extracts a corresponding user from the user information to generate a list of destination information corresponding to the user when a push notification request accompanied by information for identifying the application and a condition of the attribute value is received, and makes a push notification request accompanied by the list to a cloud service.

### CITATION LIST

### Patent Literature

Patent Literature 1: JP 2015-103031 A

### SUMMARY OF INVENTION

### Technical Problem

However, even in a case where the attribute value of the user dynamically changes, the information processing device described in Patent Literature 1 makes the push notification to the user who meets the condition of the attribute value. Therefore, although the condition of the corresponding user can be narrowed down, there is a problem that the content of the notification cannot be tested and confirmed in advance by notifying a specific user. In addition, even if the conditions can be narrowed down to users who perform test confirmation, applications used by all the users have the same specification, and thus, there is a problem that it is not possible to test confirm the notification by incorporating the provisionally changed specification into the application.

An object of the embodiments is to provide an application management program, an information processing device, and an application management system that make it possible to confirm a notification to an application and the content of the notification in advance on a specific terminal and make it possible to confirm the notification in advance even when a change is made to the application.

### Solution to Problem

In order to achieve the above-described objective, a mode of the embodiments provides the application management program, the information processing device, and the application management system described below.

One aspect of embodiments includes a application management program causing a computer to operate as: an editing means configured to edit first structure information designating a display structure of an application having a plurality of functions and a function to be used from the plurality of functions, and first content information to be used on the display structure of the application designated on the basis of the first structure information; a distribution means configured to distribute the first structure information and the first content information to a first terminal on which the application is operated, and distribute a second structure information specifying a display structure of the application and a function to be used from the plurality of functions and second content information displayed on a display structure of the application specified on the basis of the second structure information to a second terminal on which the application is operated; and a notification means configured to carry out notification processing of notifying the first terminal of notification content information, in response to reception of a test notification request together with the notification content information from the outside.

One aspect of embodiments includes the application management program according to the first embodiment further causing the computer to function as a reflection means configured to, in response to reception of a reflection request from the outside, reflect the first structure information and the first content information edited by the editing means in the second structure information and the second content information, in which the notification means is configured to carry out notification processing of notifying at least the second terminal registered in advance of the notification content information, in response to reception of an actual notification request from the outside.

One aspect of embodiments includes the application management program according to the first or the second embodiment, in which the notification content information includes a link to the first structure information and/or the first content information.

One aspect of embodiments includes the application management program according to the first embodiment, in which the notification means carries out notification processing of notifying at least the second terminal registered in advance of the notification content information upon reception of the actual notification request together with the notification content information from the outside.

One aspect of embodiments includes an application management program causing a computer to operate as: a storage means configured to store structure information designating a display structure of an application having a plurality of functions and a function to be used from the plurality of functions, content information to be used on the display structure of the application designated on the basis of the structure information, and notification content information notified to the application in the past; a distribution means configured to distribute the structure information and the content information to a terminal on which the application is operated in a case where the terminal on which the application is operated starts the application for the first time; and a notification means configured to carry out notification processing of notifying the terminal of the notification content information.

One aspect of embodiments includes an application program configured to store a display structure of an application having a plurality of functions, select and execute a function to be used from the plurality of functions on the basis of received structure information, use a content used on the display structure of the application designated on the basis of the structure information on the basis of received content information, and cause a computer to function as: an application information acquisition means configured to, upon reception of a notification, request and acquire structure information and content information of an application associated with the notification from the outside; and an application execution means configured to execute the application associated with the notification on the basis of the structure information and the content information acquired.

One aspect of embodiments includes an application program configured to store a display structure of an application having a plurality of functions, select and execute a function to be used from the plurality of functions on the basis of received structure information, use a content used on the display structure of the application designated on the basis of the structure information on the basis of received content information, and cause a computer to function as: an application information acquisition means configured to, at the time of first startup, request and acquire structure information and content information of an application, as well as latest notification content information from the outside; and an application execution means configured to, after the notification content information is subjected to display processing, execute the application on the basis of the structure information and the content information acquired.

One aspect of embodiments includes an information processing device including: an editing means configured to edit first structure information designating a display structure of an application having a plurality of functions and a function to be used from the plurality of functions, and first content information to be used on the display structure of the application designated on the basis of the first structure information; a distribution means configured to distribute the first structure information and the first content information to a first terminal on which the application is operated, and distribute a second structure information specifying a display structure of the application and a function to be used from the plurality of functions and second content information displayed on a display structure of the application specified on the basis of the second structure information to a second terminal on which the application is operated; and a notification means configured to carry out notification processing of notifying the first terminal of notification content information, in response to reception of a test notification request together with the notification content information from the outside.

One aspect of embodiments includes an application management system including: a first terminal configured to execute an application having a plurality of functions; a second terminal configured to execute the application, and an information processing device having: an editing means configured to edit first structure information designating a display structure of the application and a function to be used from the plurality of functions, and first content information to be used on the display structure of the application designated on the basis of the first structure information; a distribution means configured to distribute the first structure information and the first content information to a first terminal, and distribute a second structure information specifying a display structure of the application and a function to be used from the plurality of functions and second content information displayed on a display structure of the application specified on the basis of the second structure information to a second terminal on which the application is operated; and a notification means configured to carry out notification processing of notifying the first terminal of notification content information, in response to reception of a test notification request together with the notification content information from the outside.

### Advantageous Effects of Invention

According to the first, eighth, and ninth embodiments, it is made possible to confirm a notification to an application and the content of the notification in advance on a specific terminal and make it possible to confirm the notification in advance even when a change is made to the application.

According to the second embodiment, a notification confirmed in advance can be notified to a terminal other than a specific terminal.

According to the third embodiment, it is possible to make it possible to confirm a notification in advance when a change is made to an application.

According to the fourth embodiment, the notification can be notified to a terminal other than a specific terminal.

According to the fifth and seventh embodiment, when the application is started for the first time, the notification content information notified to the terminal in the past can be notified.

According to the sixth embodiment, when a notification is made, an application associated with the notification can be executed.

### BRIEF DESCRIPTION OF DRAWINGS

FIG. 1 is a schematic diagram illustrating an example of a configuration of an application management system according to an embodiment.

FIG. 2 is a block diagram illustrating a configuration example of an application management server according to the embodiment.

FIG. 3 is a schematic diagram illustrating an example of a configuration of distribution destination information.

FIG. 4 is a schematic diagram illustrating an example of a configuration of notification destination information.

FIG. 5 is a schematic diagram illustrating an example of a configuration of test application information and actual application information.

FIG. 6 is a block diagram illustrating a configuration example of a test terminal according to the embodiment.

FIG. 7 is a block diagram illustrating a configuration example of a terminal according to the embodiment.

FIG. 8 is a schematic diagram illustrating an example of a display screen displayed on a display unit by an application execution means in the test terminal.

FIG. 9A is a schematic diagram for describing an editing operation.

FIG. 9B is a schematic diagram for describing an editing operation.

FIG. 9C is a schematic diagram for describing an editing operation.

FIG. 10 is a flowchart showing an editing operation example of the application management system.

FIG. 11 is a flowchart showing an operation example of an application running on the test terminal.

FIG. 12 is a schematic diagram illustrating examples of the test terminal and a notification screen displayed on a display unit of the terminal.

FIG. 13 is a flowchart for explaining a test notification operation.

FIG. 14 is a schematic diagram illustrating examples of the test terminal and a notification screen displayed on a display unit of the terminal.

FIG. 15 is a flowchart for explaining a test notification operation.

FIG. 16 is a schematic diagram illustrating examples of a notification screen displayed on the display unit of the test terminal.

FIG. 17 is a flowchart for explaining an operation of the test terminal at the time of receiving a test notification.

FIG. 18 is a flowchart for explaining a notification acquisition operation at the time of the first startup of an application.

### DESCRIPTION OF EMBODIMENTS

### Embodiments

(Configuration of Application Management System)

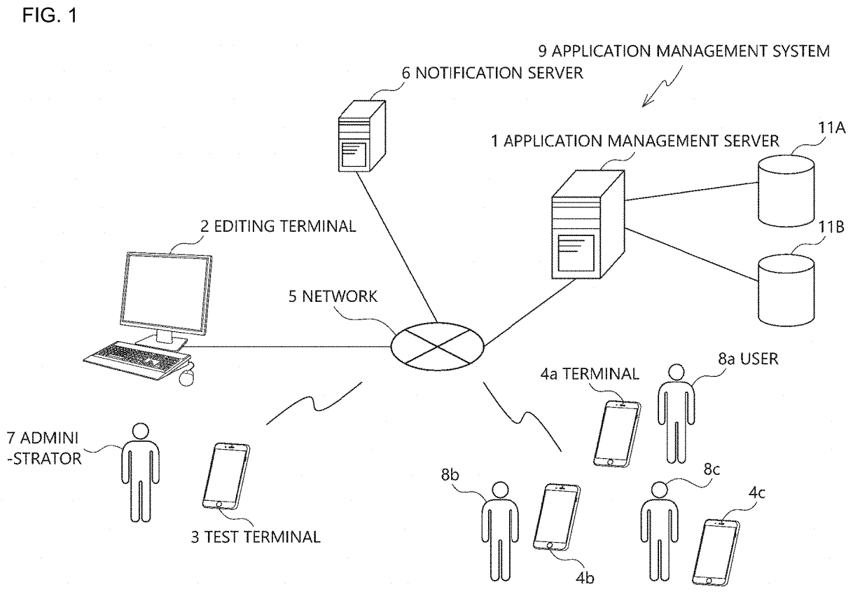

FIG. 1 is a schematic diagram illustrating an example of a configuration of an application management system according to an embodiment.

This application management system 9 is configured by communicably connecting an application management server 1 as an information processing device, an editing terminal 2, a test terminal 3 as a first terminal, and terminals 4a, 4b, 4c, . . . as second terminals via a network 5. In addition, a notification server 6 is connected as a configuration for extending the application management system 9. The editing terminal 2 and the test terminal 3 are operated by an administrator 7 who manages applications operating on the test terminal 3 and the terminals 4a, 4b, 4c . . . , and the terminals 4a, 4b, 4c . . . are operated by users 8a, 8b, 8c . . . using the applications operating on the terminals 4a, 4b, 4c . . . , respectively.

The application management server 1 is a server type information processing device, operates in response to a request from the editing terminal 2, the test terminal 3, and the terminals 4a, 4b, 4c, . . ., and includes electronic components such as a central processing unit (CPU), a hard disk drive (HDD), and a flash memory having a function for processing information in a main body. In addition, although the application management server 1 includes the storage units 11A and 11B, it is not always necessary that two storage units exist physically, and it is only required that two storage areas exist. Each of the storage units 11A and 11B stores information defining the content of the application. The information that defines the content of the application includes structure information that specifies the function, display, and the like of the application, and content information used on the application. Details of these pieces of information will be described later.

The editing terminal 2 is an information processing device such as a personal computer (PC), a smartphone, and a tablet terminal, and includes electronic components such as a CPU and a flash memory having a function for processing information in a main body. The editing terminal 2 is mainly used to edit the content of the application.

The test terminal 3 and the terminals 4a, 4b, 4c, . . . are information processing devices such as a smartphone, a tablet terminal, and a PC, and include electronic components such as a CPU and a flash memory having a function for processing information in a main body. It is assumed that an application is installed in the test terminal 3 and the terminals 4a, 4b, 4c, . . ., and the application can execute a plurality of functions in advance. For the function executed by the application, a function to be used and a function not to be used are designated on the basis of structure information included in information defining the content of the application distributed from the application management server 1, and a structure on display (hereinafter may also be referred to as a “display structure”) including a layout, coloring, arrangement of functions, and the like is designated. In addition, content information such as text, an image, a video, and audio included in the information defining the content of the application is used on the display structure.

The network 5 is a communication network enabling high-speed communication, and is, for example, a wired or wireless communication network such as an intranet or a local area network (LAN).

The notification server 6 is a server type information processing device for notifying the test terminal 3, the terminals 4a, 4b, 4c, . . . of information in response to a request from the editing terminal 2, operates in response to a request from the application management server 1, and includes electronic components such as a CPU, a HDD, and a flash memory having a function for processing information in the main body. The notification made by the notification server 6 is particularly called “push notification”, which can be made without an inquiry from the test terminal 3, the terminals 4a, 4b, 4c, . . . .

As an example, the application management server 1 operates in response to a request transmitted from the editing terminal 2 on the basis of the operation details of the administrator 7, and edits the content of the application running on the test terminal 3 or the terminals 4a, 4b, 4c . . . . However, the application management server 1 edits information defining the content of the application stored in the storage units 11A and 11B without editing the application itself distributed on the test terminal 3 or the terminals 4a, 4b, 4c . . . . Note that information defining the content of the test application is stored in the storage unit 11A, and information defining the content of the actual application is stored in the storage unit 11B. Information defining the content of the test application is distributed to the test terminal 3, and information defining the content of the actual application is distributed to the terminals 4a, 4b, 4c, . . . .

First, when editing the content of the application, the application management server 1 edits information defining the content of the test application stored in the storage unit 11A. Next, in response to the request from the test terminal 3, information defining the content of the test application in the storage unit 11A is distributed to the test terminal 3, the edited content is reflected in the application running on the test terminal 3, and the administrator 7 is caused to confirm the reflection result for the test. At this point, the application management server 1 does not reflect the edited content in the information defining the content of the actual application stored in the storage unit 11B. Therefore, the content of the applications operating on the terminals 4a, 4b, 4c, . . . are the content before editing.

The administrator 7 activates the application on the test terminal 3, checks the content of the edited application, and then operates the editing terminal 2 to make a test notification from the notification server 6 to the test terminal 3. When the notification is made to the test terminal 3, the administrator 7 checks the notification content on the edited application. When the notification content is normal, the administrator 7 confirms the edited content of the application and makes the actual notification.

In a case where the administrator 7 confirms the content of the edited application and confirms the edited content, when the editing terminal 2 is operated to reflect the same edited content also to the actual application running on the terminals 4a, 4b, 4c . . . , the application management server 1 copies or the like information defining the content of the test application in the storage unit 11A to information defining the content of the actual application stored in the storage unit 11B, to reflect the information defining the content of the test application to the information defining the content of the actual application. Next, in response to a request from the terminals 4a, 4b, and 4c . . . , information defining the content of the actual application in the storage unit 11B is distributed to the terminals 4a, 4b, and 4c . . . , and the edited content is reflected in the application running on the terminals 4a, 4b, and 4c . . . , so that the content of the application is updated without redistributing the application.

Next, the notification server 6 notifies the terminals 4a, 4b, 4c . . . of the actual notification, and the terminals 4a, 4b, 4c . . . receive the notification. The terminals 4a, 4b, 4c, . . . display notification content, activate an updated application as necessary, and display the notification content on the application.

(Configuration of Information Processing Device)

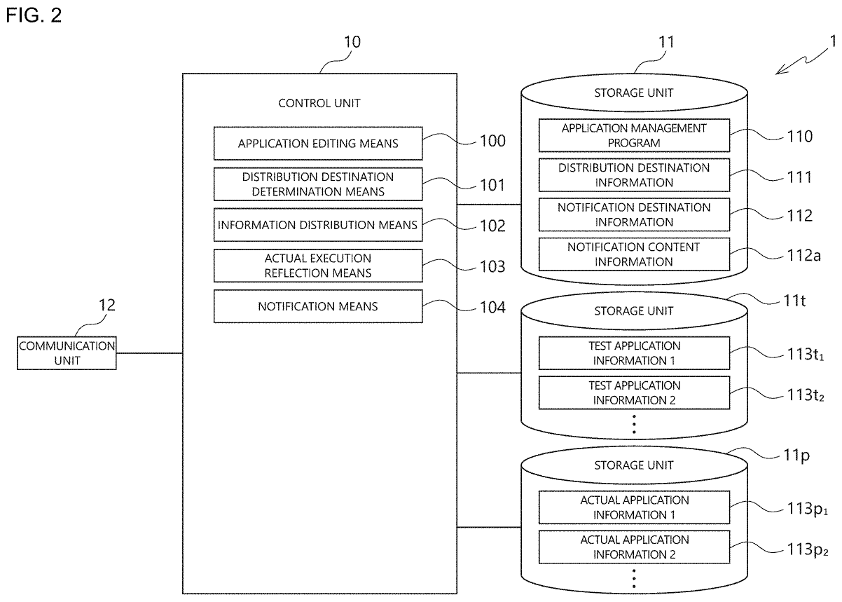

FIG. 2 is a block diagram illustrating a configuration example of an application management server 1 according to the embodiment.

The application management server 1 includes a control unit 10 that includes a CPU and the like, controls each unit, and executes various programs, storage units 11, 11A, and 11B that include a storage medium such as a flash memory and store information, and a communication unit 12 that communicates with the outside via the network 5.

The control unit 10 functions as an application editing means 100, a distribution destination determination means 101, an information distribution means 102, an actual execution reflection means 103, a notification means 104, and the like by executing an application management program 110 to be described later.

The application editing means 100 edits the test application information 113t1, 113t2, . . . , which are information defining the content of the test application, in response to a request from the editing terminal 2. Details of the configuration of the test application information 113t1, 113t2 . . . will be described later.

Upon receiving the request of the test terminal 3 or the terminals 4a, 4b, and 4c . . . , the distribution destination determination means 101 determines the distribution destination of the test application information 113t1, 113t2 . . . or the actual application information 113p1, 113p2 . . . which is information defining the content of the actual application on the basis of the distribution destination information 111.

The information distribution means 102 distributes the test application information 113t1, 113t2 . . . or the actual application information 113p1, 113p2 . . . to the test terminal 3 or the terminals 4a, 4b, 4c . . . on the basis of the determination result of the distribution destination determination means 101.

The actual execution reflection means 103 reflects the content of the test application information 113t1, 113t2 . . . in the actual application information 113p1, 113p2 . . . in response to the reflection request of the editing terminal 2.

In response to reception of the notification request from the editing terminal 2, the notification means 104 requests the notification server 6 to notify the test terminal 3 or the application running on the terminals 4a, 4b, 4c, . . . .

The storage unit 11 stores the application management program 110 for operating the control unit 10 as each means 100 to 104 described above, the distribution destination information 111, the notification destination information 112, the notification content information 112a, and the like.

The storage unit 11A stores test application information 113t1, 113t2 . . . . In addition, the storage unit 11B stores the actual application information 113p1, 113p2, . . . .

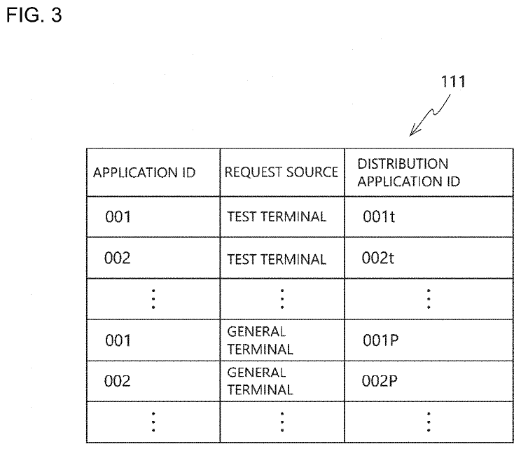

FIG. 3 is a schematic diagram illustrating an example of a configuration of the distribution destination information 111.

The distribution destination information 111 includes an application ID for identifying an application of the test terminal 3 or the terminals 4a, 4b, 4c, . . ., a request source indicating a type of a distribution request source (for test or actual distribution), and a distribution application ID for identifying application information distributed from the application management server 1.

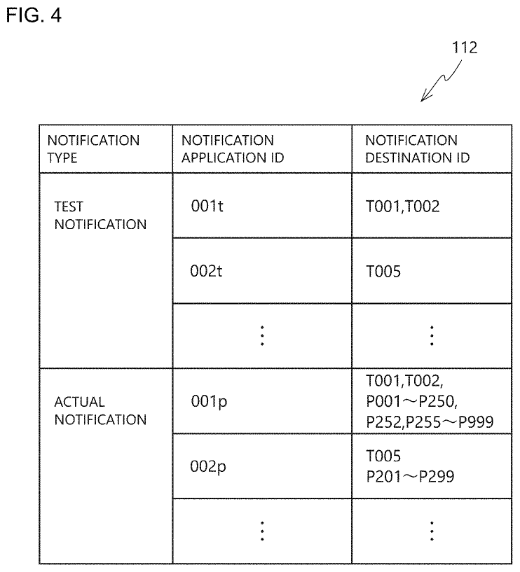

FIG. 4 is a schematic diagram illustrating an example of a configuration of the notification destination information 112.

The notification destination information 112 includes a notification type indicating either “test notification” or “actual notification”, a notification application ID indicating an ID of an application to be notified, and a notification destination ID indicating an ID of a terminal to be notified.

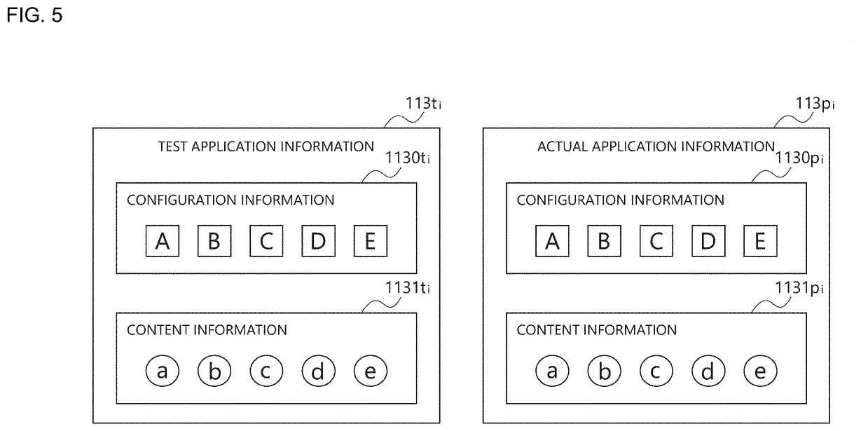

FIG. 5 is a schematic diagram illustrating an example of the configuration of test application information 113ti and actual application information 113pi.

The test application information 113ti includes: configuration information 1130ti as first configuration information that defines a display structure such as a function to be used and a function not to be used in an application running on the test terminal 3, arrangement of the function, arrangement/coloring of a display frame, and arrangement of content; and content information ll2lti as first content information such as an image, a video, audio, and a text to be used on the application. In addition, the actual application information 113pi includes: configuration information 1130pi as second configuration information that defines a display structure such as a function to be used and a function not to be used in an application running on the terminals 4a, 4b, 4c . . . , arrangement of the function, arrangement/coloring of a display frame, and arrangement of content; and content information 121pi as second content information such as an image, a video, audio, and a text to be used on the application.

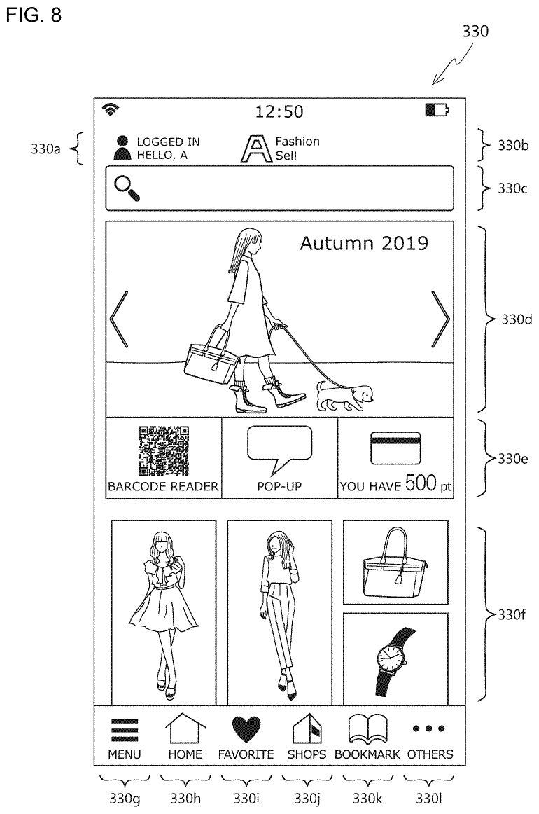

In the example illustrated in FIG. 5, in the test application information 113ti and the actual application information 113pi, the functions to be used defined in the configuration information 1130ti and 1130pi are “A, B, C, D, E”, and the other functions that are not described are functions not to be used. Details of the functions will be described later. Some of the functions will be described again in FIG. 8. Although not illustrated, the configuration information 1130ti and 1130pi also include a display structure such as a layout of a display screen, coloring, a background, arrangement of each function, screen transition, and link information.

Furthermore, “a, b, c, d, e” in the content information 1131ti and 1131pi indicate content, and the content are a text, an image, a video, audio, and the like.

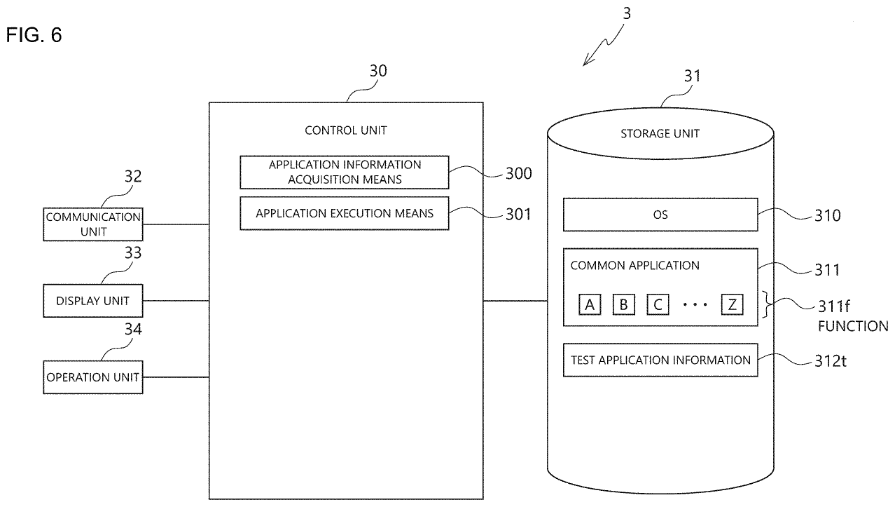

FIG. 6 is a block diagram illustrating a configuration example of a test terminal 3 according to the embodiment.

The test terminal 3 includes a control unit 30 that includes a CPU and the like and controls each unit and executes various programs, a storage unit 31 that includes a storage medium such as a flash memory and stores information, a communication unit 32 that communicates with the outside via the network 5, a display unit 33 that includes a liquid crystal display (LCD), an organic electro luminescence (EL) display, and the like and displays characters, images, and the like, and an operation unit 34 that includes a touch panel, a switch, and the like integrated with the display unit 33 and generates an operation signal.

The control unit 30 functions as an application information acquisition means 300, an application execution means 301, and the like by executing an operating system (OS) 310 and a common application 311 to be described later. The OS 310 and the common application 311 are examples of the application program.

When the common application 311 is started up, the application information acquisition means 300 transmits the ID of the application and the information for identifying the terminal to the application management server 1 via the communication unit 32 to request acquisition of the application information. In addition, the application information acquisition means 300 receives the test application information 312t as a response to the request from the application management server 1 and stores the test application information in the storage unit 31. Note that the timing of the acquisition request for the application information by the application information acquisition means 300 is not limited to the time of startup of the common application 311, and may be periodically performed at a predetermined interval, or may be performed when an update operation is performed, with no limitation.

The application execution means 301 determines a function to be used and a function not to be used among the functions 311f of the common application 311 on the basis of the acquired test application information 312t, determines arrangement of the functions, arrangement and coloring of the display frames, arrangement of the content, and the like, and executes the common application 311.

The storage unit 31 stores an OS 310 that causes the control unit 30 to operate as each means 300 and 301 described above, the common application 311, the test application information 312, and the like.

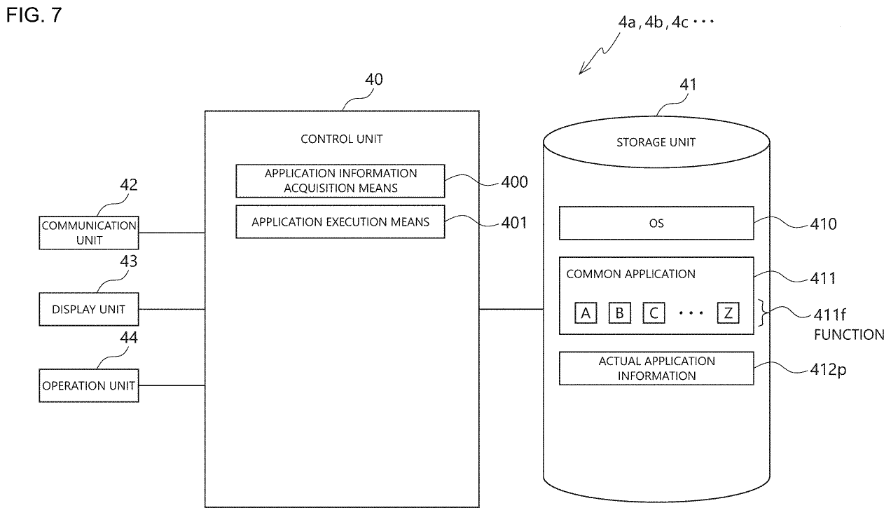

FIG. 7 is a block diagram illustrating a configuration example of the terminal 4a, 4b, 4c . . . according to the embodiment.

The terminal 4a, 4b, 4c . . . includes a control unit 40 that includes a CPU and the like and controls each unit and executes various programs, a storage unit 41 that includes a storage medium such as a flash memory and stores information, a communication unit 42 that communicates with the outside via the network 5, a display unit 43 that includes an LCD, an organic EL display, and the like and displays characters, images, and the like, and an operation unit 44 that includes a touch panel, a switch, and the like integrated with the display unit 43 and generates an operation signal.

The control unit 40 functions as an application information acquisition means 400, an application execution means 401, and the like by executing an OS 410 and a common application 411 described later.

When the common application 411 is started up, the application information acquisition means 400 transmits the ID of the application and the information for identifying the terminal to the application management server 1 via the communication unit 42 to request acquisition of the application information. In addition, the application information acquisition means 400 receives the actual application information 412p as a response to the request from the application management server 1 and stores the actual application information in the storage unit 41. Note that the timing of the acquisition request for the application information by the application information acquisition means 400 is not limited to the time of startup of the common application 411, and may be periodically performed at a predetermined interval, or may be performed when an update operation is performed, with no limitation.

The application execution means 401 determines a function to be used and a function not to be used among the functions 411f of the common application 411 on the basis of the acquired actual application information 412p, determines arrangement of the functions, arrangement and coloring of the display frames, arrangement of the content, and the like, and executes the common application 411.

The storage unit 41 stores an OS 410 that causes the control unit 40 to operate as each means 400 and 401 described above, the common application 411, test application information 412, and the like.

FIG. 8 is a schematic diagram illustrating an example of the display screen displayed on the display unit 33 by the application execution means 301 in the test terminal 3. In addition, similar screens are displayed in the terminals 4a, 4b, 4c, . . ., but description thereof is omitted since they are common.

The screen 330 includes a log-in state 330a indicating a log-in state of the user of the application to the external service, an application title field 330b displaying a title of the application, a search text box 330c for searching for a content included in the application, an image display area 330d displaying a plurality of images in a laterally slidable manner (carousel),an area 330e displaying a barcode reader, a pop-up, a point display, and the like, a product display area 330f displaying an image, a text, or the like of a product as an example of the content, a menu pop-up button 330g for displaying a menu item prepared in the application, a home button 330h for returning from the displayed screen to the home screen of the application, a favorite button 330i making a transition to a screen for displaying the content in the application registered in advance by a user, a shop button 330j making a transition to a screen for searching for a nearby sales shop using the position information, a bookmark 330k making a transition to a screen for displaying a page in the application registered in advance by a user, and an others button 330l making a transition to a screen for displaying a function not included in the button 300g to 300k.

Each configuration in the screen 330 is displayed and operated by the application execution means 301 and 401 executing the functions 311f and 411f of the common applications 311 and 411. For example, in the log-in state 330a, the configuration is displayed and operated through execution of the log-in function, and is a function of logging in to the user management system provided by the notification server 6 via the notification means 104 of the application management server 1 and using information or the like configured for each user. The application title field 330b is displayed through execution of a layout function, and is a function of displaying a title image prepared in advance according to a preset design and layout.

The search text box 330c is operated through execution of the search function, and is a function of free-word searching for content or the like displayed in the product display area 330f. The image display area 330d is displayed through execution of the layout function, and is a function of displaying a plurality of images with a predetermined setting (automatic scrolling, scrolling time, and the like) in the carousel. The area 330e is displayed and operated through execution of a layout function, and is a function of generating a barcode and transitioning to a display screen to make screen settings suitable for reading and displaying the barcode, superimposing and popping up predetermined information on the screen without screen transition, or transitioning to a screen displayed by a point function to be described later.

The case of the product display area 330f is displayed and operated through execution of the layout function, and is a function of displaying an image of a product and transitioning to a page displaying details of the product when selected. The menu pop-up button 330g is displayed and operated through execution of the layout function, and is a function of displaying a plurality of predetermined menu items and transitioning to a page of each item when selected. The home button 330h is a function of transitioning to a page displayed upon startup of the application.

The favorite button 330i is displayed and operated through execution of the favorite function, and is a function of displaying a list screen of content and pages set as the favorite by the user. The shop button 330j is displayed and operated through execution of a shop function, and is a function of acquiring current position information from a position information function such as the GPS of the test terminal 3, searching for store information close to the position information, and transitioning to a screen displaying a list. The bookmark 330k is a function of displaying a display page and a content list screen in an application set as a bookmark by the user. The others button 330l is a function of displaying a function list that is not displayed by other functions.

Furthermore, functions other than the foregoing include, for example, a push notification function for displaying a notification even when an application is not started up, a video function of displaying a video from an external video site on a display screen of an application without transitioning to the external video site, an electronic book function of displaying data such as a catalog, a flier, a book, and a cartoon in a browsable manner, a photo function of displaying an image such as a photograph in a browsable manner, a scroll menu function of displaying a plurality of articles of an external site on a display screen of an application in a scrollable manner without transitioning to the external site, an animation layout function of displaying a plurality of images in an animated manner by continuously switching therebetween, a coupon function of displaying a coupon with specification of a date and time, a web view function of displaying a web site of a specified URL with partial processing. Furthermore, functions not described herein can also be employed without departing from the scope of the present invention.

(Operation of Information Processing Device)

Next, the operation of the present embodiment will be described separately: (1) application editing operation; (2) application execution operation; (3) test notification operation; and (4) actual notification operation.

(1) Application Editing Operation

An operation of editing an application running on the test terminal 3, the terminals 4a, 4b, 4c, . . . will be described. Note that the editing operation is carried out by communication between the application management server 1 and the editing terminal 2.

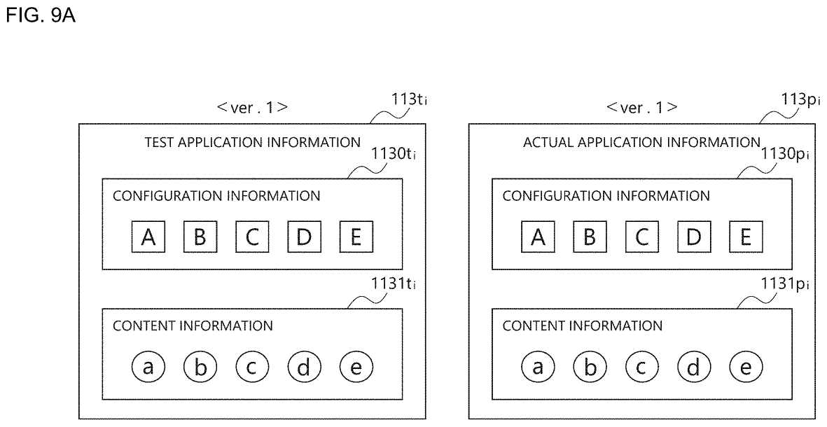

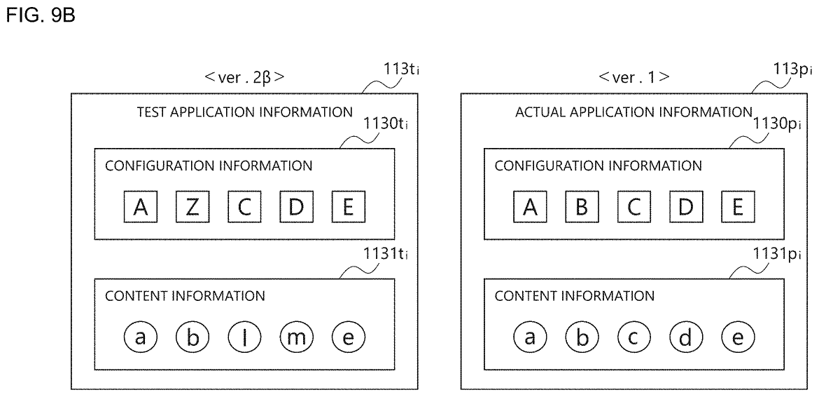

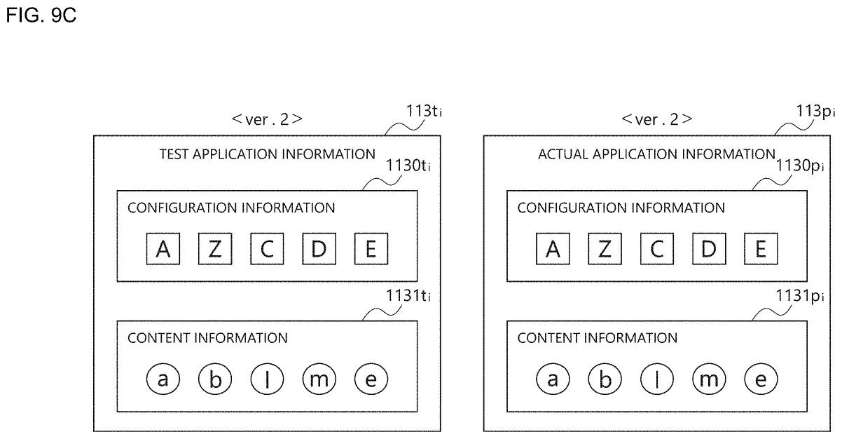

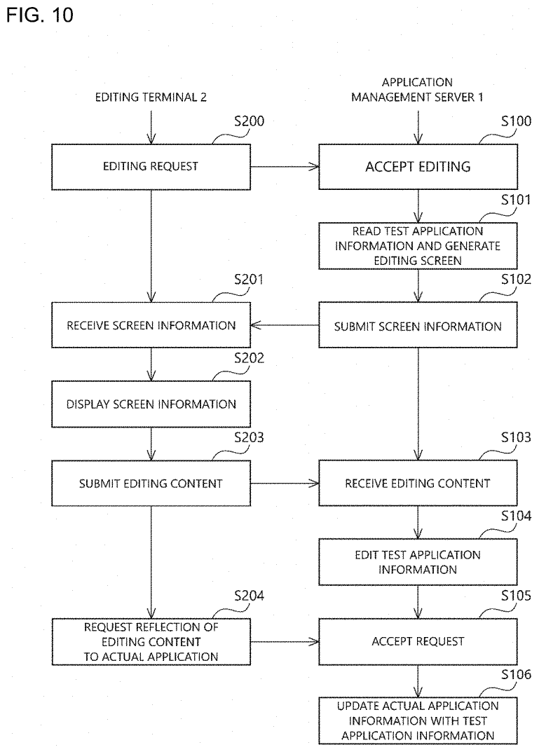

FIGS. 9A to 9C are schematic diagrams for explaining the editing operation. FIG. 10 is a flowchart showing the editing operation example of the application management system 9.

First, the administrator 7 operates the editing terminal 2 to edit the application. The editing terminal 2 transmits an editing request to the application management server 1 according to the operation details (S200).

Upon reception of the editing request from the editing terminal 2 (S100), the application management server 1 reads the test application information 113ti from the storage unit 11A, generates a screen for editing the application (S101), and transmits screen information for displaying the screen to the editing terminal 2 (S102). Note that the “i-th” of the test application information 113ti is determined on the basis of the application ID specified by the editing terminal 2.

Next, the editing terminal 2 receives the screen information from the application management server 1 (S201), and displays the screen information on the display unit of the editing terminal 2 (S202). At this point, the states of the test application information 113ti and the actual application information 113pi are as illustrated in

FIG. 9A. The version of the test application information 113ti is “ver. 1”, the function “A, B, C, D, E” is used as the configuration information 1130ti, and “a, b, c, d, e” is used as the content information 113lti. In addition, the actual application information 113pi has a version of “ver. 1” and has a similar configuration to the test application information 113ti, and a function “A, B, C, D, E” is used as the configuration information 1130pi and “a, b, c, d, e” is used as the content information 1131pi.

Next, the administrator 7 edits a portion desired to be edited by operating the operation unit while referring to the content displayed on the display unit of the editing terminal 2. The editing terminal 2 edits the content of the application according to the operation details of the administrator 7, and transmits the edited content to the application management server 1 (S203).

Next, upon reception of the edited content from the editing terminal 2 (S103), the application management server 1 reflects the edited content in the test application information 113ti (S104).

At this point, the states of the test application information 113ti and the actual application information 113pi are as illustrated in FIG. 9B. The version of the test application information 113ti is “ver. 2β”, which means before the actual confirmation, the function “A, Z, C, D, E” is used as the configuration information 1130ti, and “a, b, l, m, e” is used as the content information 1131ti. In addition, the version of the actual application information 113pi is still “ver. 1”, the function “A, B, C, D, E” is used as the configuration information 1130pi, and “a, b, c, d, e” is used as the content information 1131pi.

Next, the administrator 7 starts up an application on the test terminal 3 to confirm the edited content.

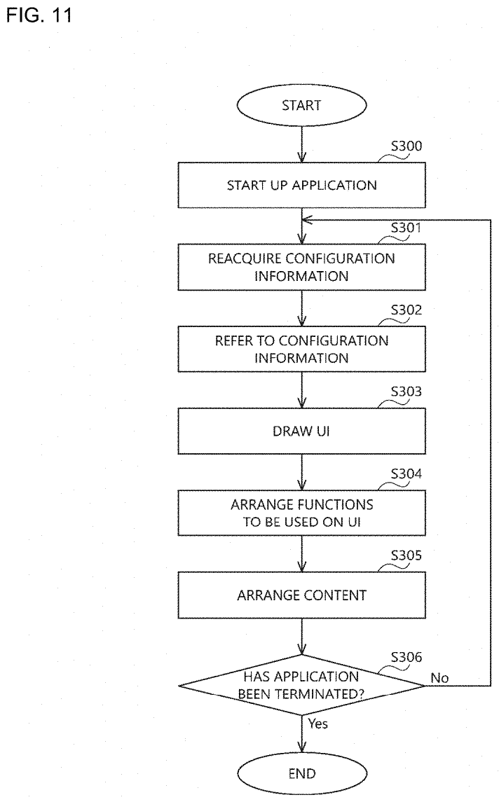

FIG. 11 is a flowchart showing an operation example of an application running on the test terminal 3.

Upon acceptance of the operation, the test terminal 3 starts up the common application 311 (S300), and the application information acquisition means 300 of the test terminal 3 reacquires the test application information 113ti from the application management server 1 and updates the test application information 312ti (S301).

Next, the application execution means 301 of the test terminal 3 refers to the acquired test application information 312ti (S302), draws the UI (S303), determines the function to be used and the function not to be used among the functions 311f of the common application 311, arranges the function to be used on the UI (S304), further arranges the content (S305), and executes the common application 311. The test application information 312t is updated at predetermined timing until the application is terminated (S306).

When the application is executed on the test terminal 3, the administrator 7 checks the content displayed on the display unit 33, checks the operation of the application with respect to the operation, and when it is confirmed that there is no problem, the administrator 7 operates the editing terminal 2 to reflect the similar edited content to the application running on the terminals 4a, 4b, and 4c.

The editing terminal 2 requests the edited content to be reflected in the actual application information 113pi according to details of the operation of the administrator 7 (S204).

In response to reception of the reflection request (S105), the actual execution reflection means 103 of the application management server 1 updates the actual application information 113pi with the test application information 113ti (S106).

At this point, the states of the test application information 113ti and the actual application information 113pi are as illustrated in FIG. 9C. The test application information 113ti is “ver. 2”, which means the fixed version, in which the function “A, Z, C, D, E” is used as the configuration information 1130ti, and “a, b, l, m, e” is used as the content information 113lti. In addition, the version of the actual application information 113pi is “ver. 2”, in which the actual application information has the same configuration as the test application information 113ti, the function “A, Z, C, D, E” is used as the configuration information 1130pi, and “a, b, l, m, e” is used as the content information 1131pi.

Next, the users 8a, 8b, 8c . . . start up applications on the terminals 4a, 4b, 4c . . . .

The operations on the terminals 4a, 4b, 4c . . . are similar to those explained in FIG. 11, and the terminals 4a, 4b, 4c . . . start the common application 411 upon acceptance of the operation (S300), and the application information acquisition means 400 of the terminals 4a, 4b, 4c . . . reacquires the actual application information 113pi from the application management server 1 and updates the actual application information 312pi (S301).

Next, the application execution means 401 of the terminals 4a, 4b, 4c . . . refers to the acquired actual application information 412pi (S302), draws the UI (S303), determines the function to be used and the function not to be used among the functions 411f of the common application 411, arranges the function to be used on the UI (S304), arranges the content (S305), and executes the common application 411.

As a result of the above operation, the users 8a, 8b, 8c . . . use the applications updated on the basis of the edited content on the terminals 4a, 4b, 4c . . . .

(2) Application Execution Operation

Among the functions of the applications running on the test terminal 3 and the terminals 4a, 4b, 4c, . . ., the function achieved in cooperation with the application management server 1 will be described.

For example, when the point function is executed by the application execution means 401 of the terminal 4a, it is necessary to access an external server not illustrated that manages points by a log-in function in advance, log in by inputting a user ID, a password, and the like, and acquire information such as a point balance.

The configuration information regarding the point function included in the actual application information 412p includes instruction information for instructing the application execution means 401 to notify the external communication means of the application management server 1 of the application ID of the terminal 4a and request the external communication means to execute an operation regarding the point function. The application execution means 401 of the terminal 4a notifies the external communication means in the application management server 1 of the application ID of the terminal 4a on the basis of the instruction information, and requests the external communication means of the application management server 1 to execute the operation for the point function.

Upon receiving a request from an application running on the terminal 4a, the external communication means of the application management server 1 refers to external communication information not illustrated, acquires an address associated with the type of the function of the notified application ID, acquires screen information for accessing the external server of the address to log in to the point service, and transmits the screen information to the terminal 4a. Thereafter, when the user ID and the password are input in the terminal 4a, the user ID and the password are transmitted to the notification server 6, and when the log-in is successful, the point balance is acquired from the notification server 6 and transmitted to the terminal 4a. In this manner, communication with the terminal 4a is mediated by a series of operations.

In addition, the log-in function, the video function, the scroll menu function, and the like are also achieved in cooperation with the application management server 1 as described above.

(3) Test Notification Operation

An operation in which the administrator 7 makes a test notification to the test terminal 3 after editing at least an application running on the test terminal 3 will be described. Note that the notification operation is carried out by communication between the application management server 1 and the editing terminal 2.

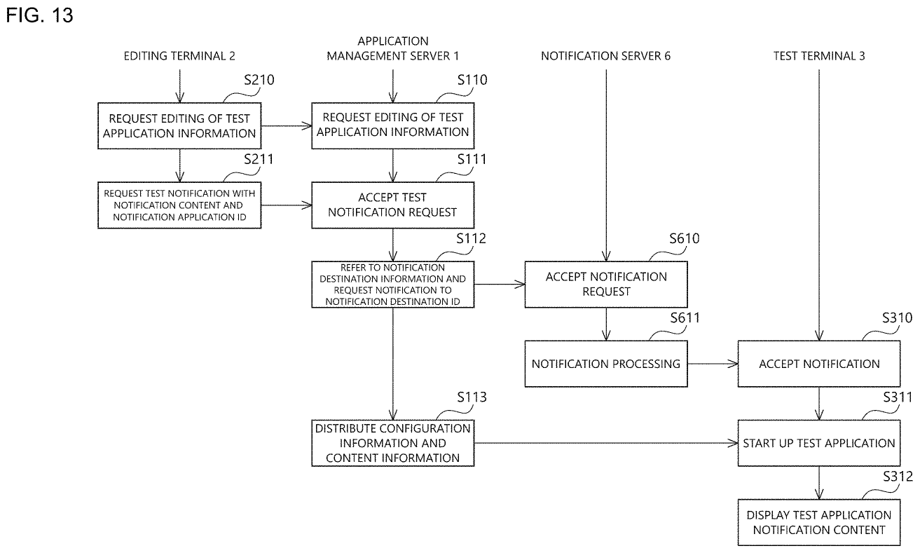

FIG. 13 is a flowchart for describing the test notification operation.

First, the administrator 7 operates the editing terminal 2 to edit an application as described in “(1) Application editing operation”. The editing terminal 2 transmits an editing request to the application management server 1 according to the operation details (S210). Here, for example, the administrator 7 edits a page on the application, that is a link destination included in the notification content, in accordance with the notification content.

When receiving the edit request from the editing terminal 2, the application management server 1 edits the test application information 113ti as described in “(1) Application editing operation” (S110).

Next, in order to make a test notification to the test terminal 3, the administrator 7 operates the editing terminal 2 to input a notification content and a notification application ID (for example, “001t”) as a notification destination. The editing terminal 2 transmits a test notification request to the application management server 1 according to the operation details (S211). Note that an operation button “Test Notification” for test notification may be prepared in advance in the editing terminal 2, and when the operation button is operated, the test notification request and the application ID being edited may be automatically transmitted from the editing terminal 2 to the application management server 1.

Upon reception of the test notification request from the editing terminal 2 (S111), the notification means 104 of the application management server 1 refers to the notification destination information 112 illustrated in FIG. 4, identifies the notification destination ID “T001, T002” corresponding to the notification application ID “001t” of which the notification type is “test notification”, and requests the notification server 6 to notify the notification destination ID “T001, T002” (S112).

Upon reception of the notification request from the application management server 1 (S610), the notification server 6 notifies the terminal corresponding to the notification destination ID “T001, T002” of the received notification content (S611). Here, it is assumed that the notification destination ID “T001” corresponds to the test terminal 3, and that the notification destination ID “T002” corresponds to a test terminal not illustrated.

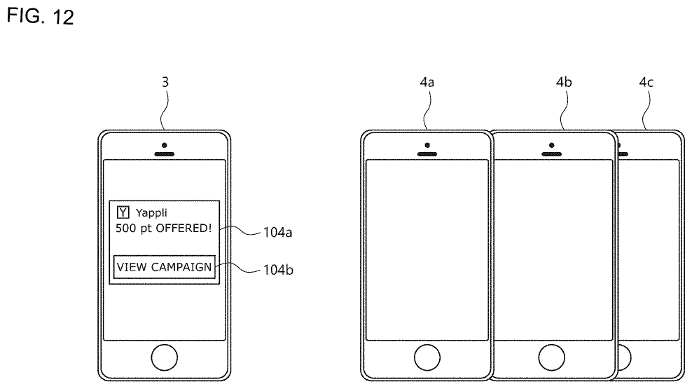

The test terminal 3 receives the notification from the notification server 6 (S310), and displays the notification content on the display unit 33 as illustrated in FIG. 12.

FIG. 12 is a schematic diagram showing an example of notification screens displayed on the display units of the test terminal 3 and the terminals 4a, 4b, 4c, . . . .

The display unit 33 of the test terminal 3 displays, for example, notification content 104a including a message such as the application name and “500 pt Offered!”, and a button 104b for starting the application in order to browse details of the notification content 104a.

In addition, since the test notification is made to the test terminal 3 at this time, the notification is not made to the terminals 4a, 4b, and 4c.

The administrator 7 checks whether the display of the notification content 104a illustrated in FIG. 12 is as intended, and operates the button 104b to determine whether the notification content are displayed as intended also on the application. The application execution means 301 of the test terminal 3 starts up the application according to the operation details of the administrator 7. At this time, as described with reference to FIG. 11, the application management server 1 distributes the test application information 113ti to the test terminal 3 (S113), and the test terminal 3 acquires the test application information 113ti from the application management server 1, updates the test application information 312t, and then starts up the application (S311).

The application of the test terminal 3 started based on the test application information 312ti edited by the administrator 7 in accordance with the notification content displays a page in the application designated as a link destination included in the notification content as the notification content (S312).

(4) Actual Notification Operation

Next, an operation in which, after the administrator 7 makes the test notification and confirms the notification content in “(3) Test notification operation”, the edited content is reflected in the actual application, and the actual notification is made to the test terminal 3 and the terminals 4a, 4b, 4c, . . . will be described. Note that the notification operation is carried out by communication between the application management server 1 and the editing terminal 2.

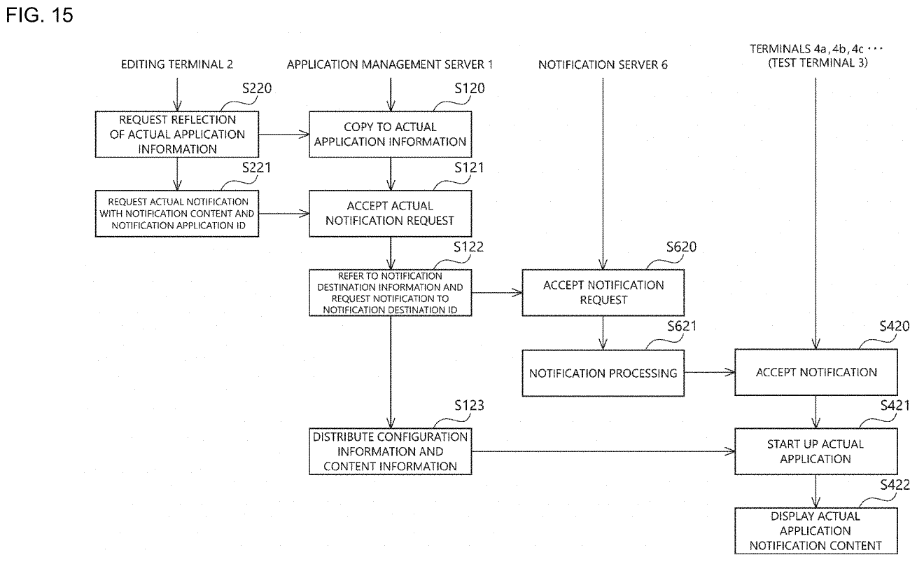

FIG. 15 is a flowchart for describing the test notification operation.

First, the administrator 7 edits the application as described in “(1) Application editing operation”, and then operates the editing terminal 2 to reflect the edited content in the actual application information. The editing terminal 2 transmits a reflection request to the application management server 1 according to the operation details (S220).

When receiving the reflection request from the editing terminal 2, the application management server 1 copies the test application information 113ti to the actual application information 113pi as described in “(1) Application editing operation” (S120).

Next, the administrator 7 operates the editing terminal 2 to input a notification content and a notification application ID (for example, “001t”) as a notification destination, in order to make an actual notification to the test terminal 3 and the terminals 4a, 4b, 4c, . . . . Note that the notification content and the notification destination may be used as they are when there is no problem with the notification content and the notification destination used in “(3) Test notification operation”. The editing terminal 2 transmits the actual notification request to the application management server 1 according to the operation details (S221). In addition, an operation button for actual notification “Actual Notification” may be prepared in advance in the editing terminal 2, and in a case where the operation button is operated, the notification content used in the test notification, the actual notification request, and the application ID may be automatically transmitted from the editing terminal 2 to the application management server 1.

When receiving the actual notification request from the editing terminal 2 (S121), the notification means 104 of the application management server 1 refers to the notification destination information 112 illustrated in FIG. 4, identifies the notification destination IDs “T001, T002, P001 to P250, P252, P255 to P999” corresponding to the notification application ID “001t” of which the notification type is “Actual Notification”, and requests the notification server 6 to notify the notification destination IDs “T001, T002, P001 to P250, P252, P255 to P999” (S122). The notification destination described in the notification application ID of the “Actual Notification” is the ID of the terminal whose notification is permitted by the user of each terminal. Here, it is assumed that the terminal 4c does not permit notification.

When receiving the notification request from the application management server 1 (S620), the notification server 6 notifies the terminal corresponding to the notification destination IDs “T001, T002, P001 to P250, P252, P255 to P999” of the received notification content (S621). Here, it is assumed that the notification destination ID “T001” corresponds to the test terminal 3, and that the notification destination ID “T002” corresponds to a test terminal not illustrated. In addition, it is assumed that the notification destination IDs “P001, P002” correspond to the terminals 4a and 4b, and the notification destination IDs “P003 to P250, P252, P255 to P999” correspond to terminals not illustrated herein.

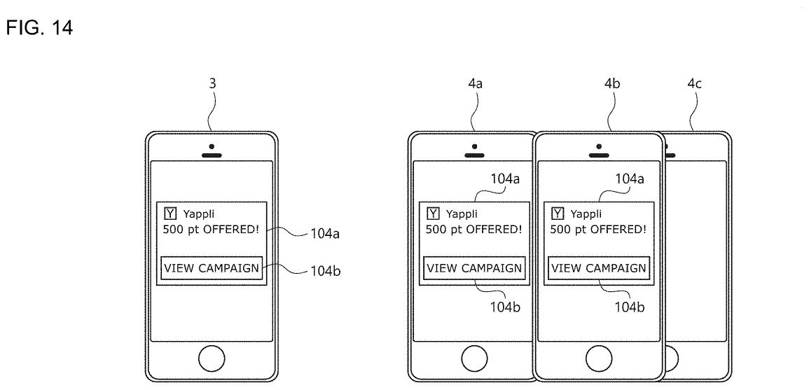

The test terminal 3 and the terminals 4a and 4b receive the notification from the notification server 6 (S420), and display the notification content on the display units 33, 43a, and 43b as illustrated in FIG. 14.

FIG. 14 is a schematic diagram illustrating an example of a notification screen displayed on the display units of the test terminal 3 and the terminals 4a and 4b.

The display unit 33 of the test terminal 3 and the display units 43a and 43b of the terminals 4a and 4b display, for example, notification content 104a including a message such as the application name and “500 pt Offered!”, and a button 104b for starting the application in order to view details of the notification content 104a. Note that in the terminal 4c, since the notification is not permitted, the notification content 104a is not displayed.

The administrator 7 confirms the display of the notification content 104a illustrated in FIG. 14 similarly to “(3) Test notification operation”, and operates the button 104b to determine whether the notification content are displayed as intended also on the application. In addition, the users 8a and 8b check the display of the notification content 104a illustrated in FIG. 14, and operate the button 104b to display the notification content on the application as desired.

The application execution means 301 of the test terminal 3 starts the application similarly to “(3) Test notification operation” according to the operation details of the administrator 7. In addition, the application execution means 401 of the terminals 4a and 4b start the application according to the operation details of the users 8a and 8b. At this time, as described with reference to FIG. 11, the application management server 1 distributes the actual application information 113pi to the terminals 4a and 4b (S123), and the terminals 4a and 4b acquire the actual application information 113pi from the application management server 1, update the actual application information 412p, and then start up the application (S421).

The applications of the terminals 4a and 4b started up on the basis of the actual application information 412p display a page in the application designated as a link destination included in the notification content as the notification content (S422).

(5) Test Notification Reception Operation

Since the test terminal 3 has the common application 311, the test terminal 3 operates as a plurality of types of applications on the basis of the test application information 312t acquired from the application management server 1. Therefore, when receiving the test notification in “(3) Test notification operation”, the test terminal 3 is started up as an application corresponding to the notification content. Hereinafter, the operation of the test terminal 3 after reception of the test notification will be described.

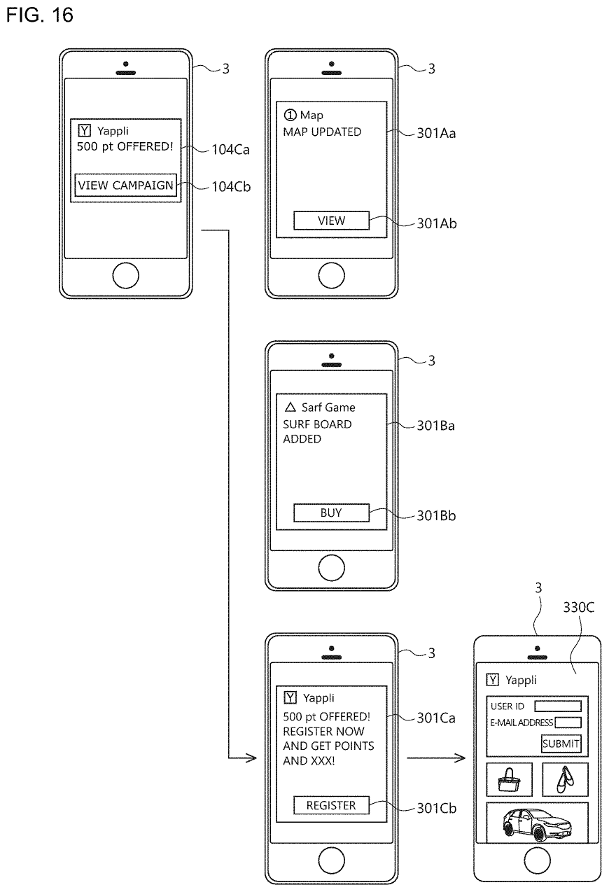

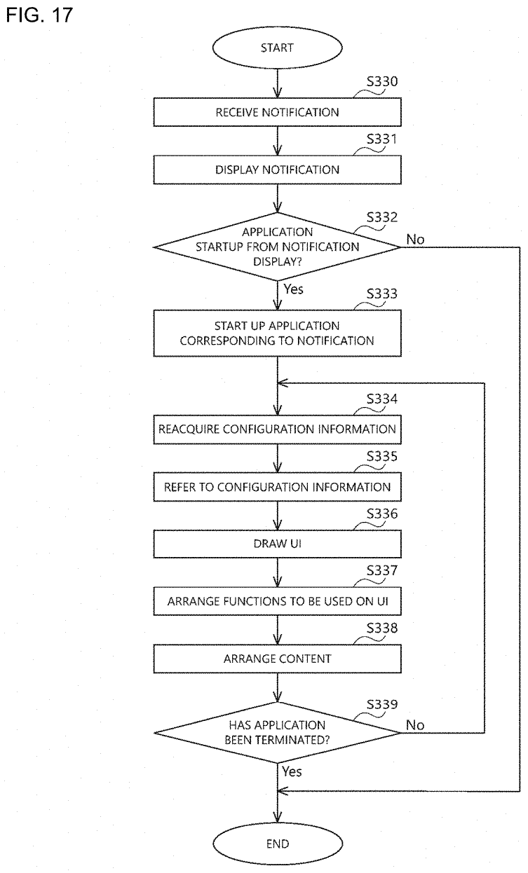

FIG. 16 is a schematic diagram illustrating examples of a notification screen displayed on the display unit of the test terminal 3. FIG. 17 is a flowchart for explaining an operation of the test terminal 3 at the time of receiving a test notification.

When receiving the notification from the notification server 6 (S330), the test terminal 3 displays a notification content 104Ca and a button 104Cb for starting the corresponding application on the display unit 33 to browse details of the notification content 104a as illustrated in FIG. 16 (S331). At this time, the test terminal 3 does not start the common application 311, and displays the notification content at an operating system (OS) level, for example. In addition, it is assumed that the common application 311 can be selected and executed from “application A”, “application B”, and “application C” on the basis of the content of the test application information 113t, and the notification content 104Ca corresponds to “application C”.

Next, when the button 104Cb illustrated in FIG. 16 is operated and the test terminal 3 receives the application start operation from the notification display (S332; Yes), in order to activate the “application C” corresponding to the notification, the test terminal 3 first starts up the common application 311 (S333), and the application information acquisition means 300 of the test terminal 3 acquires the test application information 113ti, which is the “application C” corresponding to the notification, from the application management server 1 and updates the test application information 312t (S334).

Next, the application execution means 301 of the test terminal 3 refers to the acquired test application information 312t (S335), draws the UI (S336), determines the function to be used and the function not to be used among the functions 311f of the common application 311, arranges the function to be used on the UI (S337), further arranges the content (S338), and executes the “application C” corresponding to the notification. Since the first screen displayed by the application execution means 301 is the movement from the button 104Cb, it is the notification content display 301Ca on the “application C”.

The notification content display 301Ca further includes a button 301Cb that links to another screen on the “application C”. When the button 301Cb is operated, the application execution means 301 of the test terminal 3 displays a screen 330C that is a link destination of the button 301Cb.

### Effects of Embodiment

According to the above-described embodiment, the test application information 113ti is prepared to be distributed to the test terminal 3 for change content confirmation, the actual application information 113pi is prepared to be distributed to the terminals 4a, 4b, and 4c . . . used by the general users 8a, 8b, and 8c . . . , the provisional application is edited for the test application information 113ti, the edited content is not reflected in the actual application information 113pi until the editing is confirmed, and the test notification is made to the test terminal 3 to which the test application information 113ti is distributed when the test notification is made, and the actual notification is made to the terminals 4a, 4b, and 4c . . . to which the actual application information 113pi is distributed after the distribution content is confirmed, so that the notification content can be confirmed in advance, whereby the notification content can be confirmed by the application after the change even when the notification content is accompanied by the change content of the application. In addition, in the terminals 4a, 4b, 4c, . . ., it is possible to continue to use the application with the content of the state before the change until the change is confirmed, whereby flexible notification and application update can be implemented.

In addition, the common applications 311 and 411 installed in the test terminal 3 and the terminals 4a, 4b, and 4c . . . are configured to be capable of executing all the functions 311f and 411f, and the functions to be used/not to be used are defined by the configuration information 1130ti and 1130pi included in the test application information 113ti and the actual application information 113pi. Therefore, it is not necessary to redistribute the changed application to the test terminal 3 and the terminals 4a, 4b, and 4c . . . , that is, without the need of downloading and reinstalling the changed application, the change content can be reflected in the application of the terminal, and a notification related to the change content can be made after the reflection.

### Other Embodiments

The embodiments are not limited to the above embodiment, and various modifications can be made without departing from the gist of the embodiments.

For example, in the above embodiment, the case where the notification of the test terminal 3 is accompanied by the change of the application has been described, but the notification of the test terminal 3 may not be accompanied by the change of the application. In addition, the case where the notification content includes a link to an application with a change has been described, but the notification content may include a link to an application before the change without including a link to an application with a change.

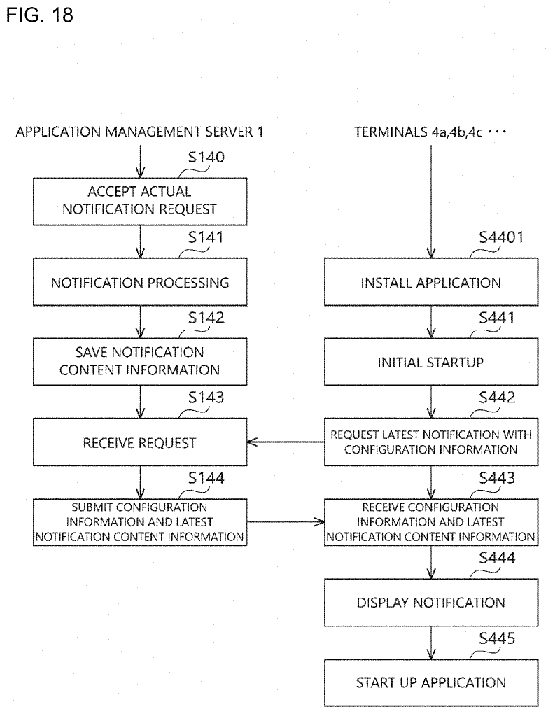

In addition, for example, the normal push notification can be received by the terminals 4a, 4b, and 4c in which the corresponding application is installed only at the timing notified from the notification server 6, and if the timing at which the application is installed in the terminal 4c is later than the timing notified from the notification server 6, the terminal 4c cannot receive the notification. However, in order to reacquire the configuration information at the time of activating the application (S301), the application execution means 401 of the present application may store the notification content in the application management server 1 in advance, and acquire the notification content from the application management server 1 at the timing of acquiring the configuration information as illustrated in FIG. 18 below.

FIG. 18 is a flowchart for explaining a notification acquisition operation at the time of the first startup of the application.

When receiving the actual notification request from the editing terminal 2 (S140), the notification means 104 of the application management server 1 performs the notification processing as described in “(4) Actual notification operation” (S141), and stores the notification content information 112a in the storage unit 11.

In the terminal 4c, when the application is newly installed (S440) and the first start operation is performed (S441), the application execution means 401 of the terminal 4c requests the configuration information to the application management server 1 in order to update the actual application information 412p, and requests the most recently stored notification content information (S442). Note that the notification content information is not limited to the latest notification content information, and may be the latest several pieces of notification content information, or notification content information may be selected and requested on the basis of information indicating the user or the usage status stored in the terminal 4c.

The information distribution means 102 of the application management server 1 receives the request from the terminal 4c (S143), and transmits the configuration information and the latest notification content information 112a to the terminal 4c (S144).

When receiving the configuration information and the latest notification content information 112a from the application management server 1 (S443), the application execution means 401 of the terminal 4c first displays the notification content on the display unit 43 on the basis of the notification content information (S444), and then starts the application (S445). The notification content displayed on the display unit 43 may be notification content displayed at the OS level or notification content displayed at the application level.

With such a configuration, even if the timing at which the application is installed on the terminal 4c is later than the timing notified from the notification server 6, since the notification content notified from the notification server 6 is stored in the application management server 1, it is possible to display the notification as if the terminal 4c has received the notification when starting up the application after the installation. Note that the timing of the notification is not limited to the first startup of the application, and in a case where the notification has not been received due to a poor communication status or the like, a notification that has not been received may be received at the time of startup of the application.

In the above embodiment, the functions of the means 100 to 104 of the control unit 10, the means 300 and 301 of the control unit 30, and the means 400 and 401 of the control unit 40 are realized by the program, but all or a part of the means may be realized by hardware such as an ASIC. In addition, the program employed in the above embodiment can be provided in a state of being stored in a recording medium such as a CD-ROM. Furthermore, replacement, deletion, addition, and the like of the steps described in the above embodiment can be made within such a scope that the gist of the embodiments is not changed.

### INDUSTRIAL APPLICABILITY

Provided are an application management program, an information processing device, and an application management system that make it possible to confirm a notification to an application and the content of the notification in advance on a specific terminal and make it possible to confirm the notification in advance even when a change is made to the application.

### REFERENCE SIGNS LIST

1 Application management server
2 Editing terminal
3 Test terminal
4a, 4b, 4c Terminal
5 Network
6 Notification server
7 Administrator
8a, 8b, 8c User
9 Application management system
10 Control unit
11 Storage unit
12 Communication unit
30 Control unit
31 Storage unit
32 Communication unit
33 Display unit
34 Operation unit
40 Control unit
41 Storage unit
42 Communication unit
43 Display unit
100 Application editing means
101 Distribution destination determination means
102 Information distribution means
103 Actual execution reflection means
104 Notification means
110 Application management program
111 Distribution destination information
112 Notification destination information
112a Notification content information
113p Actual application information
113t Test application information
300 Application information acquisition means
301 Application execution means
311 Common application
312 Test application information
400 Application information acquisition means
401 Application execution means
411 Common application
412t Test application information
412p Actual application information

1. A non-transitory computer-readable medium containing executable instructions which when executed by one or more processors of a computer, causes the computer to:
edit first structure information designating a display structure of an application having a plurality of functions and a function to be used from the plurality of functions, and first content information to be used on the display structure of the application designated on a basis of the first structure information;
distribute the first structure information and the first content information to a first terminal on which the application is operated, and distribute a second structure information specifying a display structure of the application and a function to be used from the plurality of functions and second content information displayed on a display structure of the application specified on a basis of the second structure information to a second terminal on which the application is operated; and
carry out notification processing of notifying the first terminal of notification content information, in response to reception of a test notification request together with the notification content information from an outside.

2. The non-transitory computer-readable medium according to claim 1 further causing the computer to:
in response to reception of a reflection request from the outside, reflect the edited first structure information and the edited first content information in the second structure information and the second content information, wherein
notification processing is carried out by notifying at least the second terminal registered in advance of the notification content information, in response to reception of an actual notification request from the outside.

3. The non-transitory computer-readable medium according to claim 1, wherein the notification content information includes a link to the first structure information and/or the first content information.

4. The non-transitory computer-readable medium according to claim 1, wherein notification processing is carried out by notifying at least the second terminal registered in advance of the notification content information upon reception of the actual notification request together with the notification content information from the outside.

5. A non-transitory computer-readable medium containing executable instructions which when executed by one or more processors of a computer, causes the computer to:
store structure information designating a display structure of an application having a plurality of functions and a function to be used from the plurality of functions, content information to be used on the display structure of the application designated on a basis of the structure information, and notification content information notified to the application in the past;
distribute the structure information and the content information to a terminal on which the application is operated in a case where the terminal on which the application is operated starts the application for a first time; and
carry out notification processing of notifying the terminal of the notification content information.

6. A non-transitory computer-readable medium containing executable instructions which when executed by one or more processors of a computer, causes the computer to:
store a display structure of an application having a plurality of functions, select and execute a function to be used from the plurality of functions on a basis of received structure information, use a content used on the display structure of the application designated on a basis of the structure information on a basis of received content information,
upon reception of a notification, request and acquire structure information and content information of an application associated with the notification from an outside; and
execute the application associated with the notification on a basis of the structure information and the content information acquired.

7. A non-transitory computer-readable medium containing executable instructions which when executed by one or more processors of a computer, causes the computer to:
store a display structure of an application having a plurality of functions, select and execute a function to be used from the plurality of functions on a basis of received structure information, use a content used on the display structure of the application designated on a basis of the structure information on a basis of received content information, and cause a computer to function as:
an application information acquisition means configured to, at the time of first startup, request and acquire structure information and content information of an application, as well as latest notification content information from the outside; and
an application execution means configured to, after the notification content information is subjected to display processing, execute the application on a basis of the structure information and the content information acquired.

8. An information processing device comprising:
the non-transitory computer-readable medium according to claim 1.

9. An application management system comprising:
a first terminal configured to execute an application having a plurality of functions;
a second terminal configured to execute the application; and
an information processing device comprising a non-transitory computer-readable medium according to claim 1:
